(19) United States
(12) Patent Application Publication
(10) Pub. No.: US 2016/0245432 A1
(43) Pub. Date: Aug. 25, 2016

(54) TUBES AND METHODS OF PRODUCTION AND USE THEREOF

(71) Applicants: Michael Fonfara, Chicopee, MA (US); Arthur Bessette, Belchertown, MA (US); Richard Martini, Southampton, MA (US); Gregory P. Rooke, Springfield, MA (US); Stephanie Trittschuh, Sunderland, MA (US)

(72) Inventors: Michael Fonfara, Chicopee, MA (US); Arthur Bessette, Belchertown, MA (US); Richard Martini, Southampton, MA (US); Gregory P. Rooke, Springfield, MA (US); Stephanie Trittschuh, Sunderland, MA (US)

(73) Assignee: TITEFLEX COMMERCIAL INC., Springfield, MA (US)

(21) Appl. No.: 14/398,332

(22) PCT Filed: Jul. 10, 2012
(86) PCT No.: PCT/US2012/046060

§ 371 Date: Jul. 15, 2015

Related U.S. Application Data
(60) Provisional application No. 61/642,181, filed on May 3, 2012.
(60) Provisional application No. 61/642,172, filed on May 3, 2012.

(51) Int. Cl. F16L 11/12; B32B 5/02; F16L 11/10; B32B 27/12; B32B 27/32; F16L 11/24; B32B 1/08; B32B 5/10

(52) U.S. Cl. CPC F16L 11/12; B32B 1/08; B32B 5/024; B32B 5/10; B32B 27/12; B32B 27/322; F16L 11/24; F16L 11/10; B32B 2255/02; B32B 2255/26; B32B 2262/0269; B32B 2262/101; B32B 2262/103; B32B 2307/714; B32B 2307/202; B29C 47/0023

(57) ABSTRACT

A tube including a PTFE tube, a jacket circumferentially surrounding the PTFE tube, and a protective jacket circumferentially surrounding the jacket and the PTFE tube, and methods of producing same. The jacket is formed from a plurality of plaits of fiberglass lace. The fiberglass lace includes PTFE. A method of producing a tube includes providing a PTFE tube, forming a jacket by circumferentially wrapping a plurality of plaits of fiberglass lace around the PTFE tube, and extruding a protective jacket over the jacket. The fiberglass lace includes PTFE. A method of using the tube, includes providing a tube as described herein and coupling one or more ends of the tube to one or more devices.

### CROSS-REFERENCE TO RELATED APPLICATIONS

This application claims priority to U.S. Provisional Patent Application Ser. Nos. 61/642,172 and 61/642,181, both filed on May 3, 2012. The entire contents of each of these applications is hereby incorporated by reference herein.

### BACKGROUND

Tubes are used to transport variety of fluids in various applications. In the production of food, beverages, and pharmaceuticals, such tubes must remain sterile in order to prevent contamination of the end product. Accordingly, tubes are often steam cleaned, which can cause arcing of static electricity across tubing walls that damages the tubing. Existing tubing designed to withstand steam cleaning is convoluted, which inhibits the draining of condensed water and other fluids from the tubes.

### SUMMARY OF THE INVENTION

One aspect of the invention provides a tube including: a PTFE tube, a jacket circumferentially surrounding the PTFE tube, and a protective jacket circumferentially surrounding the jacket and the PTFE tube. The jacket is formed from a plurality of plaits of fiberglass lace. The fiberglass lace includes PTFE.

This aspect of the invention can have a variety of embodiments. The jacket can be a braided jacket. The jacket can be sintered to the PTFE tube. The fiberglass lace can be formed from a plurality of strands of PTFE-coated fiberglass. Each of the plurality of plaits can be coated with PTFE after braiding.

The jacket can include one or more metal plaits. Each of the one or more metal plaits can include a single metal wire. Each of the one or more metal plaits can include a plurality of metal wires. Each of the one or more metal plaits can include between 2 and 15 metal wires. Each of the one or more metal plaits can include 7 metal wires. The one or more metal plaits can lie substantially flat with respect to longitudinal axis of the tube. The one or more metal plaits can be spaced between every other plait and every 10 plaits. The one or more metal plaits can be spaced between every four plaits.

The fiberglass lace can include one or more reinforcing strands. The one or more reinforcing strands can be aramids. The one or more reinforcing strands can be para-aramids. The one or more reinforcing strands can be aromatic polyesters. One or more of the plaits can have a ratio of fiberglass strands to reinforcing strands between 1:1 and 20:1. One or more of the plaits can have a ratio of fiberglass strands to reinforcing strands of 7:1.

The PTFE tube can have an orientation index between 0.9 and 1.0.

The protective jacket can be an extruded protective jacket. The protective jacket can be an elastomeric protective jacket. The protective jacket can include one or more thermoplastic elastomers. The protective jacket can be a single-layer protective jacket. The protective jacket can be a multi-layer protective jacket.

The protective jacket can include a reinforcing member. The reinforcing member can be helically wound. The reinforcing member can be positioned between a first layer and a second layer of the protective jacket. The reinforcing member can be selected from the group consisting of: metal, fiberglass, and para-aramids.

The protective jacket can include one or more antimicrobial agents.

The fiberglass can be S-Glass. The fiberglass can be E-Glass.

Another aspect of the invention provides a method of producing a tube. The method includes: providing a PTFE tube, forming a jacket by circumferentially wrapping a plurality of plaits of fiberglass lace around the PTFE tube, and extruding a protective jacket over the jacket. The fiberglass lace includes PTFE.

This aspect of the invention can include a variety of embodiments. The forming step can include braiding the plurality of plaits around the PTFE tube. The fiberglass lace can be formed from a plurality of strands of PTFE-coated fiberglass. Each of the plurality of plaits can be coated with PTFE after braiding.

The PTFE tube can be formed by extrusion. The PTFE tube can be formed by vertical extrusion. The PTFE tube can have an orientation index between 0.9 and 1.0. The method can further include annealing the PTFE tube to increase the orientation index. The annealing step can be performed prior to the braiding step.

The method can include sintering the tube to bond the PTFE tube to the braided jacket. The sintering step can include introducing the tube into an oven so that the tube is heated to between about 700° F. and about 725° F. The tube can be exposed to the oven for a sufficient period of time to hold the tube at a temperature between about 700° F. and about 725° F. for about 3 minutes.

Another aspect of the invention provides a tube prepared by any of the methods described herein.

Another aspect of the invention provides a method of using a tube. The method includes: providing a tube as described herein and coupling one or more ends of the tube to one or more devices.

### BRIEF DESCRIPTION OF THE DRAWINGS

For a fuller understanding of the nature and desired objects of the present invention, reference is made to the following detailed description taken in conjunction with the accompanying drawing FIGS. wherein like reference characters denote corresponding parts throughout the several views and wherein:

FIG. 1 depicts a tube according to one embodiment of the invention;

FIG. 2 depicts a method of producing a tube according to an embodiment of the invention;

FIG. 3 depicts a method of using a tube according to an embodiment of the invention

FIG. 4A provides a photograph of a cross-section of a wall of a tube according to an embodiment of the invention; and

FIG. 4B provides a photograph of the braided jacket of a tube according to an embodiment of the invention

### DEFINITIONS

The instant invention is most clearly understood with reference to the following definitions:

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them under U.S. patent law and can mean “includes,” “including,” and the like.

As used herein, the term “metal” refers to any chemical element that is a good conductor of electricity and/or heat. Examples of metals include, but are not limited to, aluminum, cadmium, niobium (also known as “columbium”), copper, gold, iron, nickel, platinum, silver, tantalum, titanium, zinc, zirconium, and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

### DETAILED DESCRIPTION OF THE INVENTION

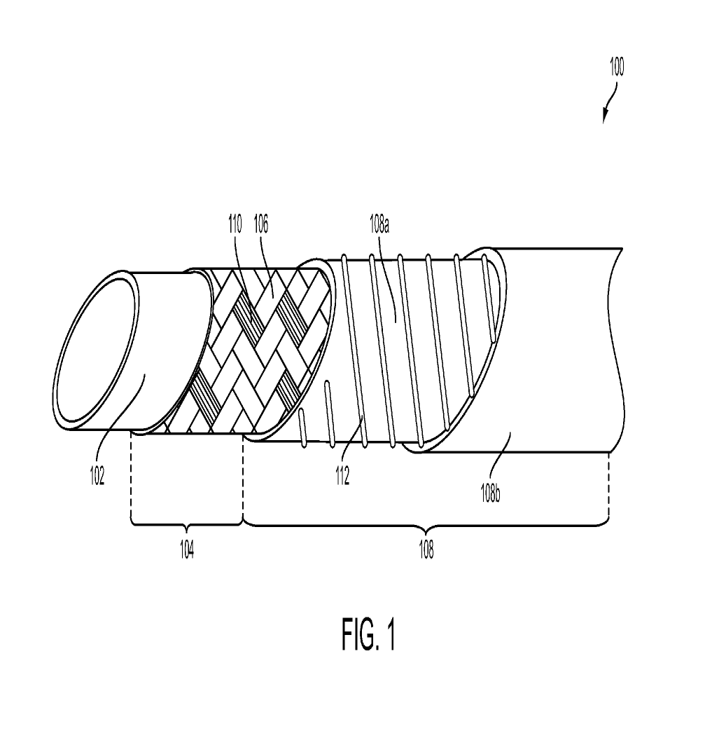

Referring now to FIG. 1, a length of tubing 100 according to one embodiment of the invention is provided. Tubing 100 includes an inner tube 102, a jacket 104 circumferentially surrounding the inner tube 102, and a protective jacket 108.

Inner tube 102 can be composed of a polymer, for example, a fluoropolymer such as polytetrafluoroethylene (PTFE). In some embodiments, the PTFE is TEFLON® T62 available from E. I. du Pont de Nemours and Company of Wilmington, Del.

The inner tube 102 can, in some embodiments, have a high orientation index, which is a measure of the degree of orientation of the PTFE chains in the longitudinal direction versus that of the transverse direction. An orientation index of zero (0) means that the PTFE chains are randomly oriented. An orientation index of one (1) means that all of the PTFE chains are oriented in the longitudinal direction.

The inner tube 102 can be completely formed and/or cured before the jacket 104 is applied over the inner tube 102.

Jacket 104 can be formed from a plurality of plaits 106 of fiberglass lace. The fiberglass lace, in turn, can incorporate PTFE. Suitable fiberglass lace is available under the A-A-52083 (Type IV) specification from a variety of sources including Breyden Products, Inc. of Columbia City, Indiana; Western Filament, Inc. of Grand Junction, Colo.; and W.F. Lake Corp. of Glens Falls, N.Y.

In some embodiments, the underlying fiberglass strands include of E-glass or S-glass. E-glass and S-glass are widely available from a variety of source. Generally speaking, E-glass is understood to refer to alumina-calcium-borosilicate glasses used as a general purpose reinforcement where strength and high electrical resistivity are desired, while S-glass is understood to refer to magnesium aluminosilicate glasses used for textile substrates or reinforcement in composite structural applications that require high strength, modulus, and durability under conditions of extreme temperature or corrosive environments. A variety of other types of fiberglass can be used including AR-glass, C-glass, D-glass, E-CR-glass, R-glass, and the like.

In some embodiments, the jacket 104 is braided as depicted in FIG. 1. In other embodiments, the jacket is formed by wrapping fiberglass plaits in a helical manner.

PTFE can be incorporated into the plaits 106 in a variety of manners. In one embodiments, each plait 106 is formed from a plurality of fiberglass strands, each of which individually coated with PTFE prior to braiding. In another embodiment, the braided plait 106 is dipped in PTFE to coat the braided plait 106.

Each plait 106 can have a substantially rectangular cross-section. That is, each plait 106 can have a width substantially greater than a height. In such an embodiment, the plaits 106 can be arranged in the braided jacket such that the wider side of the plaits 106 contacted inner tube 102. Such an arrangement minimizes the thickness of braided jacket 104 and provides more structural support to inner tube 102.

Each plait 106 can be formed from a plurality of individual strands of fiberglass. For example, each plait 106 can be formed from between 5 and 19 strands.

One or more reinforcing strands can be incorporated one or more of the plaits 106. For example, one or more aramid, para-aramid, or aromatic polyester strands can be braided along with the fiberglass strands. Suitable aramids and para-aramids are sold under the KEVLAR® brand by E. I. du Pont de Nemours and Company of Wilmington, Del., under the TECHNORA® brand by Teijin Limited of Osaka, Japan, and under the TWARON® brand by Teijin Aramid B.V. of Arnhem, The Netherlands. Suitable aromatic polyesters are available under the VECTRAN(r) and VECTRAN® EX brands from Kuraray America, Inc. of Fort Mill, S.C. The ratio of fiberglass strands to reinforcing strands can, for example, be between 1:1 and 20:1.

The jacket can also include one or more metal plaits 110 for additional strength. The metal plaits 110 can be incorporated into the jacket 104 in place of one or more fiberglass plaits 106. For example, the spacing of metal plaits 110 can range from every other fiberglass plait 106 to every 10 fiberglass plaits 110 in order to optimize strength vs. stiffness of the tube 100. The metal plaits 110 can include a one or more wires (e.g., between 1 and 15) that can lay flat or can be braided. For example, as seen in FIG. 1, six wires can be laid side-to-side so that each has a substantially uniform distance from the center of the tube 100. The metal wires can be selected from a variety of metals including stainless steel. In one particular embodiment, a plait of seven .0011″ diameter stainless steel wires is placed in every fourth bobbin.

The jacket 104 can be conductive. For example, the jacket 104 can include a plurality of conductive particles such as metal particles (e.g., copper, aluminum, gold, silver, nickel, and the like), carbon black, carbon fibers, or other conductive additives. Such particles can be present in the individual strands of fiberglass, applied to the fiberglass plaits 106, and/or applied to the jacket 104 after formation. For example, any of the strands, plaits 106, or jacket 104 can be dipped in a dispersion of conductive particles, which are then retained.

The jacket 104 can be sintered to the inner tube 102 to provide structural stability that prevents the inner tube 102 from collapsing, deforming, or bursting as will be discussed in greater detail below.

Protective jacket 108 can be a single layer jacket or a multi-layer jacket (the latter being depicted as an inner protective jacket layer 108a and outer protective jacket layer 108b in FIG. 1). At its simplest, protective jacket 108 can be an elastomeric protective jacket that is extruded over jacket 104. The protective jacket 108 can be formed from one or more thermoplastic elastomers. The protective jacket can include one or more reinforcing members 112 such as metal wires, fiberglass, aramids, para-aramids, and aromatic polyesters. In some embodiments, the one or more reinforcing members 112 are wrapped at a different pitch and/or direction than metal plaits 110, thereby stiffening tube 100. For example, reinforcing member can be a 0.0040″ diameter stainless steel wire wrapped at a W pitch (i.e., reinforcing member 112 advances ¼″ with each revolution around tube 100).

The protective jacket forms a chemical bond with the fiberglass jacket and reinforcing member 112 forms a further physical bond that holds protective jacket 108 against fiberglass jacket 104.

In some embodiments, the protective jacket 108 includes one or more anti-microbial agents incorporated within the polymer. In some embodiments, one or more components of tube 100 are certified under Class VI by the U.S. Pharmacopeial Convention of Rockville, Md.

Additionally or alternatively, the protective jacket 108 can include one or more anti-blocking agents impart a waxy feel to the elastomer(s) in protective jacket 108, thereby making the protective jacket 108 easier to clean. For example between about 0.5% and about 2.5% (by weight) of a mineral or metal salt can be added to the elastomer.

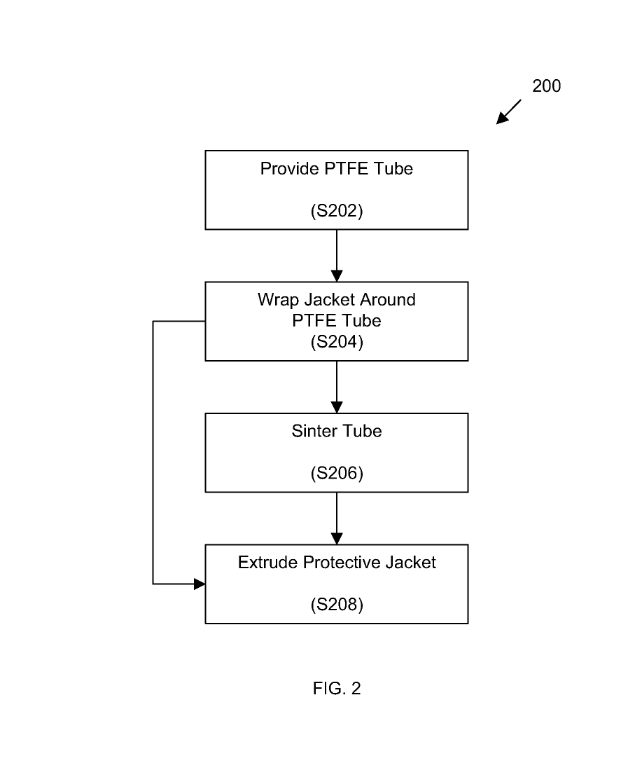

Referring now to FIG. 2, a method 200 of producing a tube according to an embodiment of the invention is provided.

In step S202, a PTFE tube is provided. The PTFE tube can be fabricated or can be obtained from a variety of sources. In some embodiments, the PTFE tube is formed by extrusion. For example, TEFLON® T62 PTFE can be mixed with ISOPAR™ G isoparaffin fluid available from ExxonMobile Chemical Company of Houston, Texas and extruded. Advantageously, PTFE tubes can be formed by vertical extrusion, in which the tube is extruded downward through a die (instead of the usual horizontal extrusion) in order to produce a tube with a high orientation index as discussed herein. Suitable vertically-extruded PTFE tubes are available from Titeflex Corporation of Springfield, Mass. Alternatively, the PTFE tube can be annealed (e.g., while hanging vertically) to increase the orientation index. This annealing step can be performed prior to the braiding step.

In step S204, a jacket is circumferentially wrapped around the PTFE tube. In some embodiments, the jacket is a braided. In other embodiments, the jacket is helically wrapped. The jacket can be formed from a plurality of plaits of fiberglass lace using standard braiding and rope making techniques and equipment. As discussed above, the fiberglass lace can include PTFE and/or one or more reinforcing strands.

In step S206, the assembled tube is optionally sintered to bond the PTFE tube to the braided jacket. The sintering step can include introducing the tube into an oven so that the tube is heated to between about 700° F. and about 725° F. The speed, length, and/or temperature of the oven can be controlled so that the tube is held at this temperature from between about 2 minutes and about 4 minutes (e.g., about 3 minutes). For example, the tube can pass through a 6′ oven at a rate of 24″/minute.

In step S208, a protective jacket is extruded over the fiberglass jacket using standard techniques and equipment such as a pressure die or a shrink die.

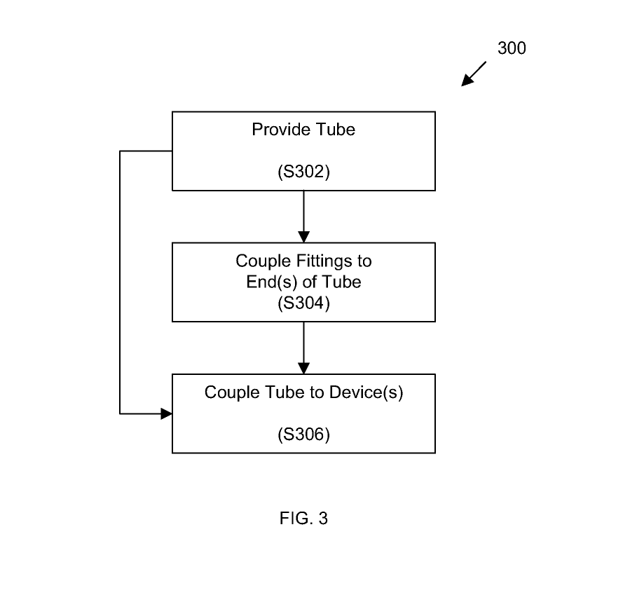

Referring now to FIG. 3, a method 300 of using a tube as described herein is provided.

In step S302, a tube is provided. The tube can be of the types described herein.

In step S304, one or more fittings can be coupled with one or more ends of the tube. The fittings can, for example, be of conventional types used in the automotive and aerospace industries.

In step S306, one or more ends of the tube are coupled to one or more devices. For example, a first end of a tube can be connected to a fluid source such as a tank and a second end of a tube can be connected to a fluid sink such as a mixer.

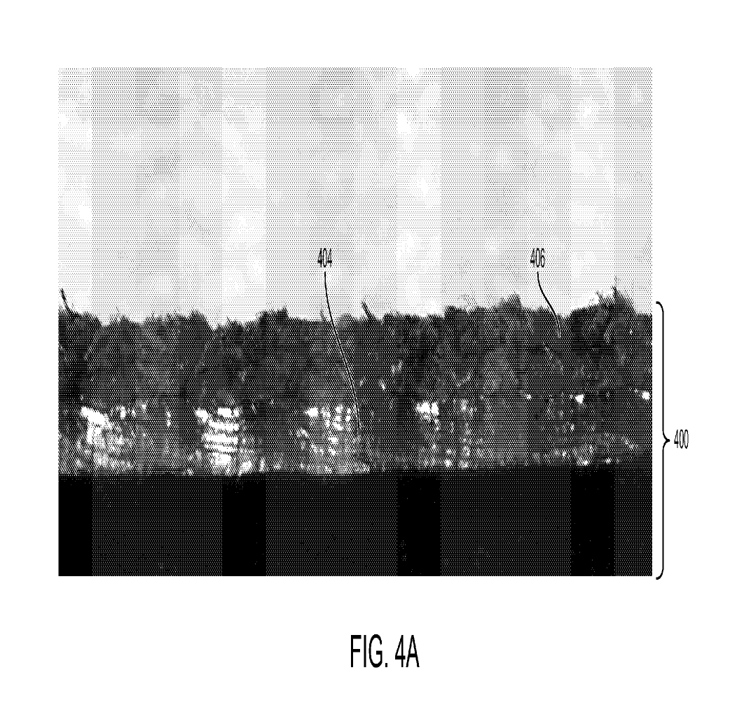

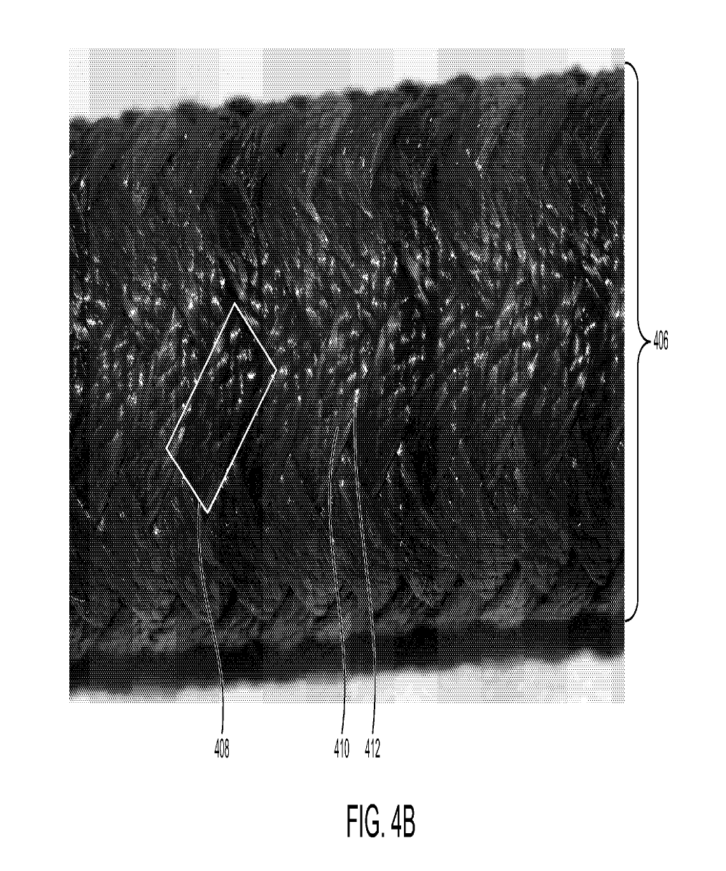

Referring now to FIGS. 4A and 4B, exterior and cross-sectional views are provided of a tube 400 according to an embodiment of invention. The depicted tube 400 lacks a protective jacket, which can optionally be applied over tube 400.

FIG. 4A provides a photograph of a cross-section a wall of the tube 400. The tube includes (moving outward from a central axis) a PTFE inner core layer 404 surrounded by a braided jacket 406.

FIG. 4B provides a photograph of the braided jacket 406 of the tube 400. Although the depicted tube 400 has a dark pigment, individual plaits 408 of fiberglass lace are visible and an exemplary plait 408 is called out by a white rectangle. Within the plaits 408 of fiberglass lace, fiberglass strands 410 and aramid strands 412 are visible. The fiberglass strands 410 are darker than the aramid strands 412.

### Equivalents

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

### Incorporation by Reference

The entire contents of all patents, published patent applications, and other references cited herein are hereby expressly incorporated herein in their entireties by reference.

1. A tube comprising:
a PTFE tube;
a jacket circumferentially surrounding the PTFE tube; and
a protective jacket circumferentially surrounding the jacket and the PTFE tube,
wherein the jacket is formed from a plurality of plaits of fiberglass lace, and
wherein the fiberglass lace includes PTFE.

2. The tube of claim 1, wherein the jacket is a braided jacket.

3. The tube of claim 1, wherein the jacket is sintered to the PIPE tube.

4. The tube of claim 1, wherein the fiberglass lace is formed from a plurality of strands of PTFE-coated fiberglass.

5. The tube of claim 1, wherein each of the plurality of plaits is coated with PTFE after braiding.

6. The tube of claim 1, wherein the jacket includes one or more metal plaits.

7. The tube of claim 6, wherein each of the one or more metal plaits includes a single metal wire.

8. The tube of claim 6, wherein each of the one or more metal plaits includes a plurality of metal wires.

9. The tube of claim 6, wherein each of the one or more metal plaits includes between 2 and 15 metal wires.

10. The tube of claim 6, wherein each of the one or more metal plaits includes 7 metal wires.

11. The tube of claim 6, wherein the one or more metal plaits lie substantially flat with respect to longitudinal axis of the tube.

12. The tube of claim 6, wherein the one or more metal plaits are spaced between every other plait and every 10 plaits.

13. The tube of claim 6, wherein the one or more metal plaits are spaced between every four plaits.

14. The tube of claim 1, wherein the fiberglass lace includes one or more reinforcing strands.

15. The tube of claim 14, wherein the one or more reinforcing strands are aramids.

16. The tube of claim 14, wherein the one or more reinforcing strands are para-aramids.

17. The tube of claim 14, wherein the one or more reinforcing strands are aromatic polyesters.

18. The tube of claim 14, wherein one or more of the plaits has a ratio of fiberglass strands to reinforcing strands between 1:1 and 20:1.

19. The tube of claim 14, wherein one or more of the plaits has a ratio of fiberglass strands to reinforcing strands of 7:1.

20. The tube of claim 1, wherein the PTFE tube has an orientation index between 0.9 and 1.0.

21. The tube of claim 1, wherein the protective jacket is an extruded protective jacket.

22. The tube of claim 1, wherein the protective jacket is an elastomeric protective jacket.

23. The tube of claim 22, wherein the protective jacket includes one or more thermoplastic elastomers.

24. The tube of claim 1, wherein the protective jacket is a single-layer protective jacket.

25. The tube of claim 1, wherein the protective jacket is a multi-layer protective jacket.

26. The tube of claim 1, wherein the protective jacket includes a reinforcing member.

27. The tube of claim 26, wherein the reinforcing member is helically wound.

28. The tube of claim 26, wherein the reinforcing member is positioned between a first layer and a second layer of the protective jacket.

29. The tube of claim 26, wherein the reinforcing member is selected from the group consisting of: metal, fiberglass, and para-aramids.

30. The tube of claim 1, wherein the protective jacket includes one or more antimicrobial agents.

31. The tube of claim 1, wherein the fiberglass is S-Glass.

32. The tube of claim 1, wherein the fiberglass is E-Glass.

33. A method of producing a tube, the method comprising:
providing a PTFE tube;
forming a jacket by circumferentially wrapping a plurality of plaits of fiberglass lace around the PTFE tube; and
extruding a protective jacket over the jacket,
wherein the fiberglass lace includes PTFE.

34. The method of claim 33, wherein the forming step includes braiding the plurality of plaits around the PTFE tube.

35. The method of claim 33, wherein the fiberglass lace is formed from a plurality of strands of PTFE-coated fiberglass.

36. The method of claim 33, wherein each of the plurality of plaits is coated with PTFE after braiding.

37. The method of claim 33, wherein the PTFE tube is formed by extrusion.

38. The method of claim 37, wherein the PTFE tube is formed by vertical extrusion.

39. The method of claim 33, wherein the PTFE tube has an orientation index between 0.9 and 1.0.

40. The method of claim 33, further comprising: annealing the PTFE tube to increase the orientation index.

41. The method of claim 40, wherein the annealing step is performed prior to the braiding step.

42. The method of claim 33, further comprising:
sintering the tube to bond the PTFE tube to the braided jacket.

43. The method of claim 33, wherein the sintering step includes introducing the tube into an oven so that the tube is heated to between about 700° F. and about 725° F.

44. The method of claim 43, wherein the tube is exposed to the oven for a sufficient period of time to hold the tube at a temperature between about 700° F. and about 725° F. for about 3 minutes.

45. A tube prepared by the method of claim 33.

46. A method of using a tube, the method comprising:
providing a tube of claim 1; and
coupling one or more ends of the tube to one or more devices.
